(19) United States
(12) Patent Application Publication
(10) Pub. No.: US 2012/0155003 A1
(43) Pub. Date: Jun. 21, 2012

(54) RETRACTABLE MOUSE PAD FOR COMPUTERS

(75) Inventors: MEHMET DONDURUR, CROFTON, MD (US); AHMET Z. SAHIN, DHAHRAN (SA)

(73) Assignee: KING FAHD UNIVERSITY OF PETROLEUM AND MINERALS, DHAHRAN (SA)

(21) Appl. No.: 12/970,746

(22) Filed: Dec. 16, 2010

(51) Int. Cl. G06F 1/16

(52) U.S. Cl. 361/679.08; 361/679.4

(57) ABSTRACT

The retractable mouse pad for computers provides a mouse pad that is built into the housing of a portable computer or other portable electronic device, such as a laptop computer, a notebook computer or the like, or, alternatively, into the housing of a computer keyboard or the like. The housing has a slot formed therein, preferably along a lateral edge thereof. The slot is in open communication with a recess defined within the housing. A substantially planar plate having opposed upper and lower surfaces is slidably and releasably disposed within the recess. The upper surface of the plate is adapted for supporting a computer mouse, and the lower surface is adapted for mounting on a support surface, such as a desktop or the like. The plate is automatically driven to at least partially slide through the slot to an exterior of the housing.

### BACKGROUND OF THE INVENTION

1. Field of the Invention

The present invention relates generally to computers and computer keyboards, and particularly to a retractable mouse pad for computers that may be stored within, and transported with, a portable computer, computer keyboard or the like.

2. Description of the Related Art

Many personal computer operators use a mouse in operating a computer, particularly for the control of a computer cursor. Typically, the mouse is a small electronic box on roller(s) or using optical components that is moved about on a hard flat surface, known as a “mouse pad”. While the mouse can be used on certain surfaces, such as a tabletop, with some success, it is more common and convenient to have a dedicated pad on which to move the mouse.

With a stationary personal computer, it is usually straightforward to find an area to place the pad and mouse on a semi-permanent basis. However, with a portable or notebook type computer, it is often inconvenient to find a suitable space to put the pad and mouse near the computer, and the size of the typical pad makes it difficult to use with the portable computer in most mobile or transportable settings. Therefore, a need exists to develop a more effective mouse pad that is more readily adapted for use with a portable computer. Thus, a retractable mouse pad for computers solving the aforementioned problems is desired.

### SUMMARY OF THE INVENTION

The retractable mouse pad for computers provides a mouse pad that is built into the housing of a portable computer or other portable electronic device, such as a laptop computer, a notebook computer or the like, or, alternatively, into the housing of a computer keyboard or the like. The housing has a slot formed therein, preferably along a lateral edge thereof. The slot is in open communication with a recess defined within the housing. A substantially planar plate having opposed upper and lower surfaces is slidably and releasably disposed within the recess. The upper surface of the plate is adapted for supporting a computer mouse, and the lower surface is adapted for mounting on a support surface, such as a desktop or the like. The substantially planar plate is automatically driven to at least partially slide through the slot to the exterior of the housing.

Preferably, the plate is resiliently biased against an inner wall of the housing, where the inner wall at least partially defines the recess. The plate preferably is substantially rectangular and has a pair of longitudinally opposed side edges and a pair of laterally opposed side edges, plate being slidable along the longitudinal direction. At least one engaging member is mounted on at least one of the laterally opposed side edges for releasably engaging at least one slidable latch member, which is slidably mounted within the housing and at least partially projects into the recess. A button or any other suitable type of switch is mounted on an exterior of the housing, allowing the user to actuate a motor, a linear actuator or the like to slide the at least one latching member away from the at least one engaging member to selectively deploy the plate.

These and other features of the present invention will become readily apparent upon further review of the following specification and drawings.

### BRIEF DESCRIPTION OF THE DRAWINGS

FIG. 1 is an environmental perspective view of a retractable mouse pad for computers according to the present invention.

FIG. 2 is a partial environmental top view of the retractable mouse pad for computers of FIG. 1, the computer being broken away and partially in section to show details of the retractable mouse pad installation.

FIG. 3 is a schematic diagram of a motorized latch assembly for a retractable mouse pad for computers according to the present invention.

FIG. 4 is an environmental perspective view of an alternative embodiment of a retractable mouse pad, shown in use with a conventional computer keyboard.

Similar reference characters denote corresponding features consistently throughout the attached drawings.

### DETAILED DESCRIPTION OF THE PREFERRED EMBODIMENTS

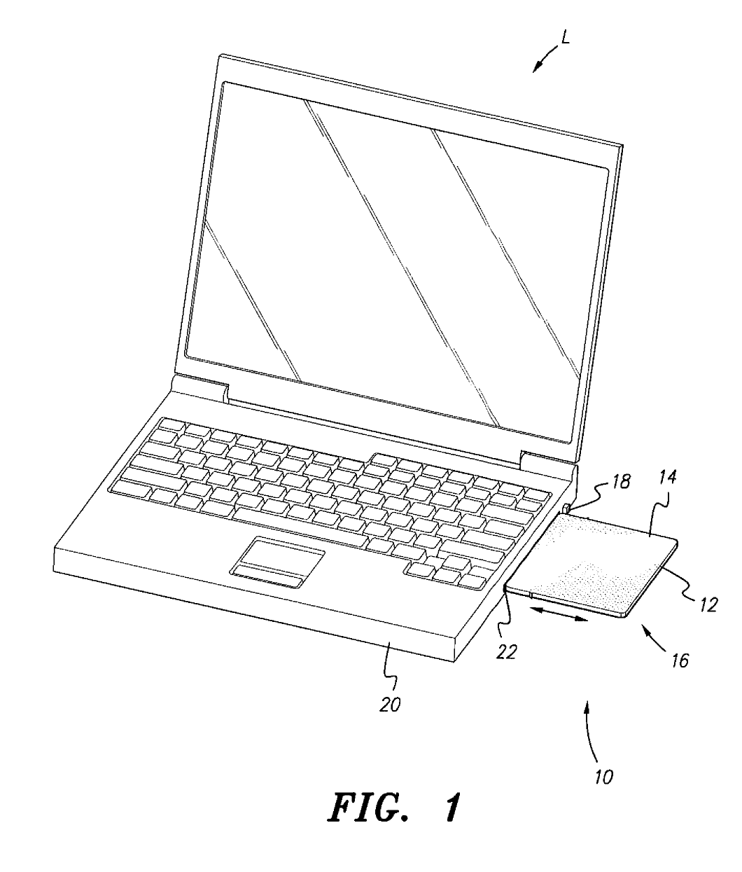

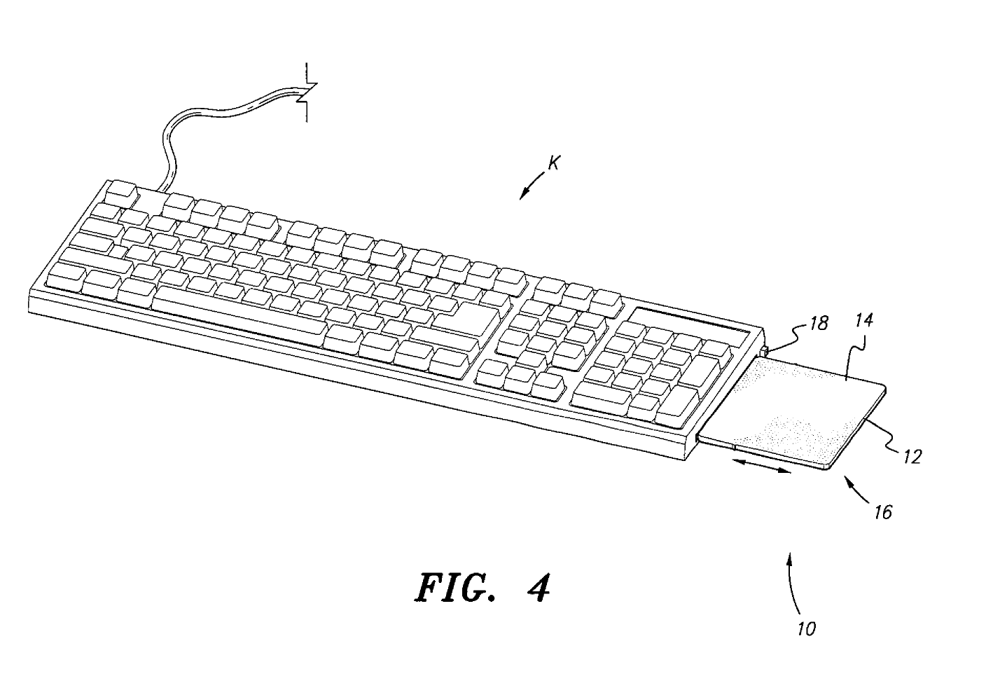

The retractable mouse pad for computers 10 provides a mouse pad that is built into the housing of a portable computer or other portable electronic device, such as the exemplary laptop computer L illustrated in FIG. 1, a notebook computer or the like. Alternatively, as shown in FIG. 4, the mouse pad 10 may be built into a computer keyboard K. It should be understood that the retractable mouse pad 10 may be built into any desired housing of any suitable type of electronic or computer device. Preferably, the mouse pad projects through a slot formed through a lateral edge of the computer or keyboard housing, positioning the mouse pad to the side of the keyboard. It should be understood that the mouse pad may also be positioned opposite from the side illustrated in FIGS. 1 and 4 (i.e., the right hand side) for left handed users, or may extend from the front of the housing.

As shown in FIG. 1, the retractable mouse pad 10 includes a substantially planar plate 12 having opposed upper and lower surfaces 14, 16, respectively. The plate 12 is slidably and removably disposed within a recess 22 formed in the housing 20 of the laptop computer L. The planar plate 12 may be formed from any suitable, substantially rigid material, such as hard plastic, aluminum, light metal or the like. The lower surface 14 of the plate 12 is adapted for resting on a support surface, such as a desk or the like. The upper surface 16 is smooth, flat, continuous, and adapted for engaging the ball of a ball mouse or reflecting the light generated by an optical mouse. It should be understood that the shape and relative dimensions of the planar plate 12 shown in FIGS. 1, 2 and 4 are for exemplary purposes only. The planar plate 12 may have be substantially rectangular, and may, for example, have a length of approximately four inches, a width of approximately four inches, and a thickness of approximately 2/8 of an inch to approximately ⅜ of an inch.

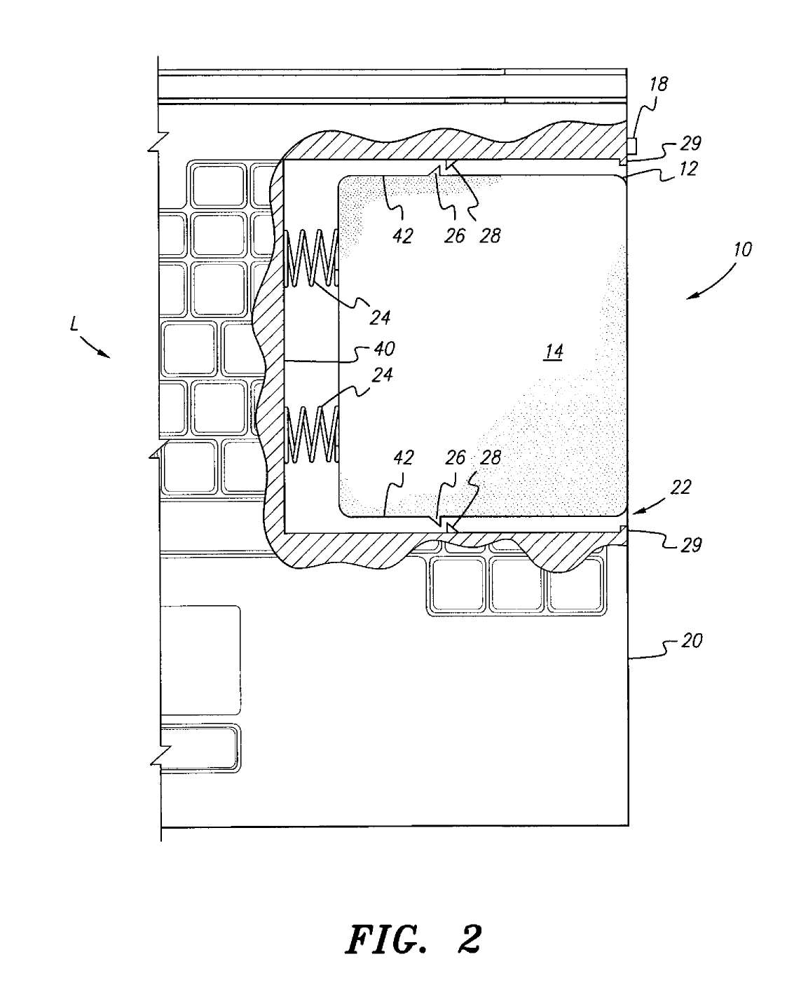

As best shown in FIG. 2, the planar plate 12 is resiliently or spring-biased against a wall or edge 40 defining the recess 22 within the housing 20 by at least one resilient member 24, such as the exemplary helical springs illustrated in FIG. 2. The planar plate 12 preferably is substantially rectangular, and has a pair of laterally opposed side edges 42. At least one engaging member 26 is preferably mounted on at least one of the side edges 42. In FIG. 2, two such engaging members 26 are provided, each of the members 26 being mounted on a respective side edge 42. Each engaging member 26 frictionally engages a respective sliding latch 28.

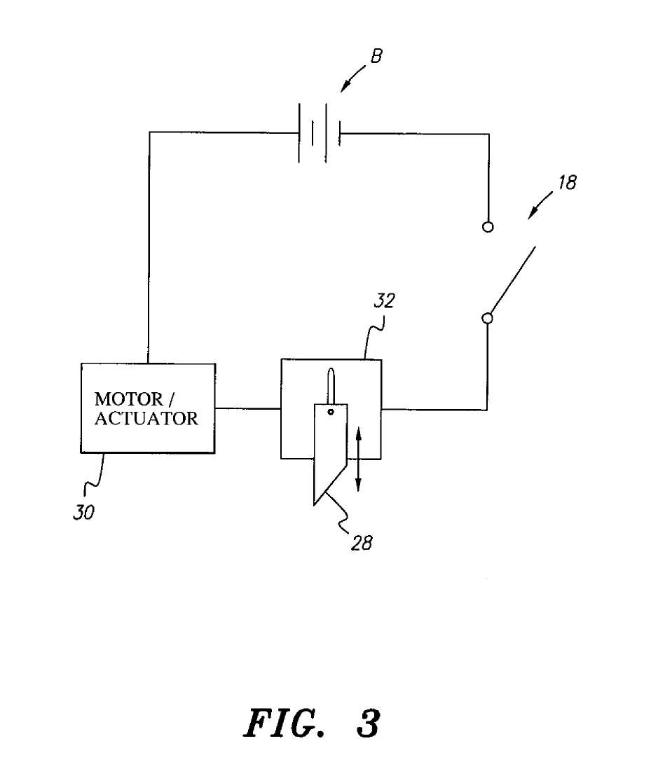

When the user wishes to deploy the planar plate 12 of the mouse pad 10, the user pushes a button or actuator 18 on the exterior of housing 20. It should be understood that the button 18 is exemplary, and may be mounted on any suitable portion of housing 20, or may be integrated into the keys or buttons of the computer L or keyboard K. As shown in FIG. 3, the button or actuator 18 is a switch for actuating a motor 30, a linear actuator or the like, mounted within the housing 20 for driving each latch 28 to translate away from the respective engaging member 26. In FIG. 3, a single latch 28 is shown as being slidably mounted on a support surface 32, and is driven to slide into the housing by motor or linear actuator 30, which is powered by the battery B of the computer. It should be understood that any driven latching mechanism may be used for controllably releasing the planar plate 12 to slide within housing 20, and that the latching assembly illustrated in FIGS. 2 and 3 is shown for exemplary purposes only.

As noted above, the planar plate 12 is resiliently biased against the surface 40 by springs 24. Thus, when the latches 28 are slid into the housing 20 and away from the engaging elements 26, the planar plate 12 slides out into the position illustrated in FIGS. 1 and 4 for use. When the user wishes to retract the planar plate 12, the use manually slides the planar plate 12 back into the recess 22 so that the engaging members 26 are once again held against the latches 28 and frictional engagement holds the planar plate 12 within the recess 22. As best shown in FIG. 2, a pair of projecting members 29 may be mounted on the housing 20 adjacent the slot formed therein for engaging the engaging members 26 in order to prevent the planar plate 12 from being removed completely from the recess 22.

It will be understood that the latching and bias arrangement shown in the drawings is exemplary, and alternative latching and bias structures are possible. For example, the planar plate 12 may be mounted on a track and guide structure, the latching and bias components may be mounted on the lower or side surface of the plate 12, and the button 18 or other release component may be mounted on a face plate attached to the front of the planar plate 12, similar to the mounting arrangement for an optical drive.

It is to be understood that the present invention is not limited to the embodiments described above, but encompasses any and all embodiments within the scope of the following claims.

We claim:

1. A retractable mouse pad for computers, comprising:
a keyboard housing having a recess formed therein, the recess defining a slot opening into the recess;
a substantially planar plate having opposed upper and lower surfaces, the upper surface being adapted for supporting a computer mouse, the plate being slidable and releasably disposed within the recess; and
means for selectively and automatically driving the substantially planar plate to at least partially slide through the slot to an exterior of the keyboard housing.

2. The retractable mouse pad for computers as recited in claim 1, wherein said substantially planar plate is resiliently biased against an inner wall of the keyboard housing, the inner wall at least partially defining the recess.

3. The retractable mouse pad for computers as recited in claim 2, wherein said means for selectively and automatically driving the substantially planar plate to at least partially slidably translate through the slot comprises at least one latch for selectively and releasably securing said substantially planar plate within the recess.

4. The retractable mouse pad for computers as recited in claim 3, wherein said substantially planar plate is substantially rectangular.

5. The retractable mouse pad for computers as recited in claim 4, wherein said plate has a pair of longitudinally opposed side edges and a pair of laterally opposed side edges, said plate being slidable along the longitudinal direction, the retractable mouse pad further comprising at least one engaging member mounted on at least one of the laterally opposed side edges and at least one corresponding slidable latching member slidably mounted to the keyboard housing.

6. The retractable mouse pad for computers as recited in claim 5, further comprising at least one motor selectively driving the at least one slidable latching member to slide along the lateral direction to selectively release the at least one engaging member and deploy the substantially planar plate.

7. The retractable mouse pad for computers as recited in claim 5, further comprising at least one linear actuator for selectively driving the at least one slidable latching member to slide along the lateral direction to selectively releasing the at least one engaging member and deploy the substantially planar plate.

8. The retractable mouse pad for computers as recited in claim 5, wherein the lower surface of said substantially planar plate is adapted for positioning on a support surface.

9. The retractable mouse pad for computers as recited in claim 5, wherein said means for selectively and automatically driving the substantially planar plate to at least partially slide through the slot further comprises a switch mounted on an exterior surface of said keyboard housing.

10. The retractable mouse pad for computers as recited in claim 9, further comprising means for preventing said plate from being completely removed from within the recess.

11. A retractable mouse pad for computers, comprising:
a portable computer housing having a recess formed therein, the recess defining a slot opening into the recess;
a substantially planar plate having opposed upper and lower surfaces, the upper surface being adapted for supporting a computer mouse, the plate being slidable and releasably received within the recess; and
means for selectively and automatically driving the plate to at least partially slide through the slot to an exterior of the portable computer housing.

12. The retractable mouse pad for computers as recited in claim 11, wherein said plate is resiliently biased against an inner wall of said portable computer housing, the inner wall at least partially defining the recess.

13. The retractable mouse pad for computers as recited in claim 12, wherein said means for selectively and automatically driving the substantially planar plate to at least partially slide through the slot comprises at least one latch for selectively and releasably securing said substantially planar plate within the recess.

14. The retractable mouse pad for computers as recited in claim 13, wherein said plate is substantially rectangular.

15. The retractable mouse pad for computers as recited in claim 14, wherein said plate has a pair of longitudinally opposed side edges and a pair of laterally opposed side edges, said plate being slidable along the longitudinal direction, the retractable mouse pad further comprising at least one engaging member mounted on at least one of the laterally opposed side edges and at least one corresponding slidable latching member slidably mounted to the portable computer housing.

16. The retractable mouse pad for computers as recited in claim 15, further comprising at least one motor selectively driving the at least one slidable latching member to slide along the lateral direction to selectively release the at least one engaging member and deploy the substantially planar plate.

17. The retractable mouse pad for computers as recited in claim 15, further comprising at least one linear actuator for selectively driving the at least one slidable latching member to slide along the lateral direction to selectively release the at least one engaging member and deploy the substantially planar plate.

18. The retractable mouse pad for computers as recited in claim 15, wherein the lower surface of said plate is adapted for positioning on a support surface.

19. The retractable mouse pad for computers as recited in claim 15, wherein said means for selectively and automatically driving the substantially planar plate to at least partially slidably translate through the slot further comprises a switch mounted on an exterior surface of said portable computer housing.

20. The retractable mouse pad for computers as recited in claim 19, further comprising means for preventing said substantially planar plate from being completely removed from within the recess.
